(19) United States
(12) Patent Application Publication
(10) Pub. No.: US 2007/0229449 A1
(43) Pub. Date: Oct. 4, 2007

(54) Liquid crystal display device

(76) Inventors: Tae-Hyeog Jung, Suwon-si (KR); Woin-Ki Cho, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 11/708,497

(22) Filed: Feb. 21, 2007

(30) Foreign Application Priority Data
Mar. 28, 2006 (KR) 10-2006-0028114

(51) Int. Cl. G09G 3/36

(52) U.S. Cl. 345/102; 345/55; 345/694; 345/84; 345/87

(57) ABSTRACT

A liquid crystal display panel may include a panel pattern, a backlight, and a prism sheet disposed between the liquid crystal display panel and the backlight, the prism sheet including a light condensing pattern unit on a side facing the liquid crystal display panel, wherein a pattern pitch A of the panel pattern unit and a pattern pitch p of the light condensing pattern unit satisfy formula 1 below:

0.3≦(A/p−N)≦0.7 (formula 1)

where N is an integer part of A/p.

### BACKGROUND OF THE INVENTION

1. Field of the Invention

The present invention relates to a liquid crystal display device. More particularly, the present invention pertains to a liquid crystal display device having a prism sheet.

2. Description of the Related Art

A liquid crystal display (LCD) device may generally use a prism sheet to increase brightness. The prism sheet may include a flat light incidence surface on one side and a light-emitting surface on the other side. Multiple light condensing patterns may be formed from triangular linear prisms on the light-emitting surface. The prism sheet may be suitable for use in a liquid crystal display device using a light guide plate, where a large portion of light from a lamp of a backlight may be incident on the incidence surface at an acute angle.

However, a problematic moiré phenomenon due to optical interference may occur when displaying images, and this phenomenon may be due to the prism sheet used for improving brightness.

To reduce the moiré phenomenon, the related art may utilize light condensing surfaces in a light condensing pattern unit at an angle between about 70 and about 110°.

However, this technique may fail to consider the relation between the prism sheet pattern and the LCD panel pattern, but this technique may only consider the angle between the light condensing surfaces of the prism sheet. As a result, the occurrence of the moiré effect may still be considerable.

### SUMMARY OF THE INVENTION

The present invention is therefore directed to a liquid crystal display device which substantially overcomes on or more of the problems due to the limitations and disadvantages of the related art.

It is therefore a feature of an embodiment of the present invention to provide a liquid crystal display device with a prism sheet.

At least one of the above and other features and advantages of the present invention may be realized by providing a liquid crystal display device that may include a liquid crystal display panel which includes a panel pattern unit, a backlight, and a prism sheet which may be disposed between the liquid crystal display panel and the backlight, and the prism sheet may include a light condensing pattern unit on a side facing the liquid crystal display panel, wherein a pattern pitch A of the panel pattern unit and a pattern pitch p of the light condensing pattern unit may satisfy: 0.3≦(A/p−N)≦0.7, where N is an integer part of A/p.

The A/p−N value may be approximately 0.5. The panel pattern unit may be between pixels of the liquid crystal display panel. The panel pattern unit may be a wiring pattern of the liquid crystal display panel. An angle between the pattern of the panel pattern unit and the pattern of light condensing pattern unit may be about 0° or about 90°. The light condensing pattern unit may have a stripe form. The panel pattern unit may have a mesh form. The panel pattern may have a stripe form.

At least one of the above and other features and advantages of the present invention may be realized by providing a liquid crystal display device that may include a panel pattern unit, a light source, and a prism sheet that may be disposed between the panel pattern unit and the light source, and the prism sheet may include a light condensing pattern unit on a side facing the panel pattern unit, where a pattern pitch A of the panel pattern unit and a pattern pitch p of the light condensing pattern unit may satisfy: 0.3≦(A/p−N)≦0.7, where N is an integer part of A/p.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 illustrates a schematic sectional view of an LCD device according to an embodiment of the present invention;

FIG. 2 illustrates a partial perspective view of a prism sheet of FIG. 1;

FIG. 3 illustrates a schematic plan view of light-focusing pattern units of a prism sheet and panel pattern units of an LCD panel according to an embodiment of the present invention;

FIG. 4 illustrates a schematic plan view of light-focusing pattern units of a prism sheet and panel pattern units of an LCD panel according to another embodiment of the present invention; and

FIG. 5 illustrates a sectional view of an LCD device according to an embodiment of the present invention.

### DETAILED DESCRIPTION OF THE INVENTION

Korean Patent Application No. 10-2006-0028114, filed on Mar. 28, 2006, in the Korean Intellectual Property Office, and entitled: “Liquid Crystal Display Device,” is incorporated by reference herein in its entirety.

The present invention will now be described more fully hereinafter with reference to the accompanying drawings, in which exemplary embodiments of the invention are illustrated. The invention may, however, be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

According to the present invention, the moiré effect may be reduced by controlling the mismatch between the pattern pitch of the panel pattern unit in the LCD panel and the pattern pitch of the light condensing pattern unit of prism sheet to be in the range of about 0.3 to 0.7.

The present invention will now be described more fully with reference to the accompanying drawings, in which exemplary embodiments of the invention are shown.

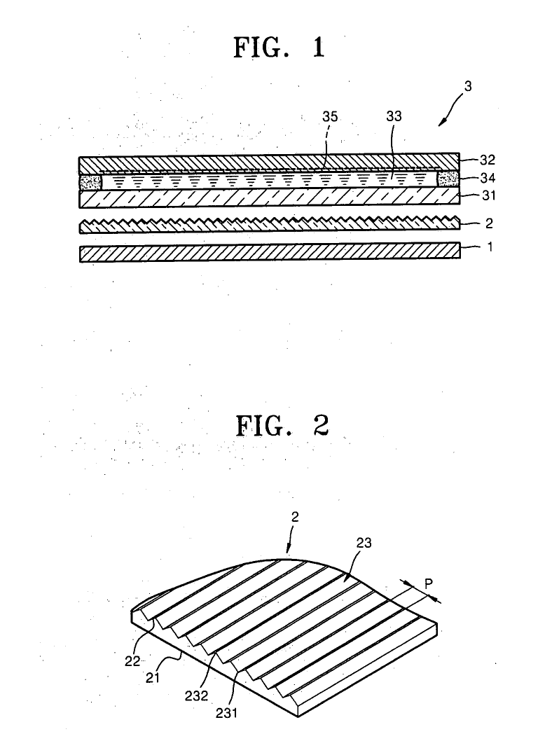

FIG. 1 illustrates a schematic sectional view of a liquid crystal display (LCD) device according to an embodiment of the present invention.

Referring to FIG. 1, the LCD device may include an LCD panel 3 which displays images, a backlight 1 which may function as a light source of the LCD panel 3, and a prism sheet 2 which may be disposed between the LCD panel 3 and the backlight 1.

The LCD panel 3 may have a structure in which a first substrate 31 and a second substrate 32 may be bonded by a sealant 34 to face each other. A liquid crystal 33 may be disposed between the first substrate 31 and the second substrate 32. The liquid crystal 33 may be, e.g., a nematic or twisted nematic material having either a positive or negative dielectric anisotropy.

The LCD panel 3 may include a panel pattern unit 35 having a predetermined pattern. The panel pattern unit 35 may be on the second substrate 32, and the second substrate 32 may be disposed on a side of the LCD panel 3 from which displayed images can be seen.

The panel pattern unit 35 may include various patterns which rarely transmit light, i.e., inhibit light transmission. The pattern may be, e.g., a light absorbing pattern including a black matrix disposed between pixels, various types of wiring patterns, an insulation layer which hardly transmits light, etc.

The backlight 1 may be utilized because the LCD panel 3 may display images by exploiting an external light source. The backlight 1 may be attached to or be in conjunction with the exterior surface of the first substrate 31. The backlight 1 may be of various types. Examples of the backlight 1 may include, e.g., a backlight including a lamp and a light guide plate, an LED backlight, etc.

A prism sheet 2 may be disposed between the backlight 1 and the liquid crystal display panel 3.

FIG. 2 illustrates that the prism sheet 2 may include a light condensing pattern unit 23. The prism sheet 2 may be a flat light-permeable plate, one side of which is a flat incidence surface 21 and other side of which is an emitting surface 22 which may include the light condensing pattern unit 23. Concave parts 231 and convex parts 232 may alternately be on the light condensing pattern unit 23 to create a stripe pattern with predetermined spacing.

Light irradiated from the backlight 1 may be incident on the incidence surface 21 of the prism sheet 2, and the light may emerge through the emitting surface 22 and irradiate the LCD panel 3.

The inventors of the present invention found that a moiré effect produced by the prism sheet 2 may be caused by interference of light from the light condensing pattern unit 23 of the prism sheet 2 with the panel pattern unit 35 of the LCD panel 3.

Since the recurrence cycle of the regularly repetitive light condensing pattern unit 23 may differ from that of the regularly repetitive panel pattern unit 35, a mismatch of the repetitive patterns may occur to cause a differentiation in line thickness where the repetitive light condensing pattern and panel pattern contact each other, thereby producing a moiré effect.

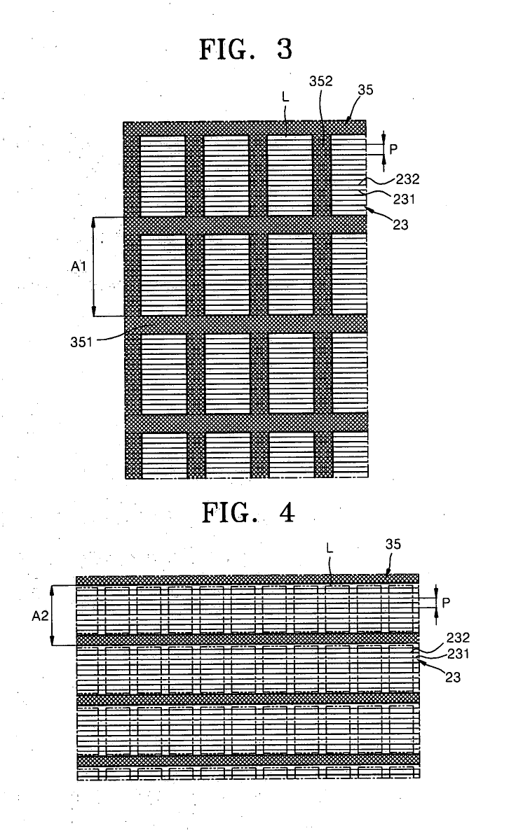

FIG. 3 illustrates a view of the relationship between the panel pattern unit 35 and the light condensing pattern unit 23. FIG. 3 illustrates the overlap of the panel pattern unit 35 and the light condensing pattern unit 23.

Referring to FIG. 3, the panel pattern unit 35 may be in a mesh, and pixels (L) may be disposed between the panel pattern unit 35 in the mesh. The pixels (L) may be disposed in a predetermined pattern of red (R), green (G), and blue (B) colors.

The panel pattern unit 35 may be a black matrix pattern, which is a light absorbing pattern.

As shown in FIG. 3, the panel pattern unit 35 may have a repetitive stripe pattern including a first stripe pattern 351 that may extend in a horizontal direction and be repetitively aligned in a vertical direction with a pitch A1. A second stripe pattern 352 extending in the vertical direction may be repetitively aligned in the horizontal direction with a pitch A2.

Concave parts 231 and Convex parts 232 may be disposed in the light condensing pattern unit 23 perpendicular or parallel to the panel pattern unit 35 in the mesh. The light condensing pattern unit 23 may be in a stripe pattern parallel to the first stripe pattern 351, and the light condensing pattern unit 23 may have a pitch p.

The pitch A1 of the first stripe pattern 351 and the pitch p of the light condensing pattern unit 23 may satisfy the relation in Formula 1 below.

0.3≦(A1/p−N)≦0.7 (Formula 1)

where N corresponds to an integer part of A1/p. The moiré effect may be greatly reduced when the decimal part of the pitch A1 of the first stripe pattern 351 divided by the pitch p of the light condensing pattern unit 23 is in the range of about 0.3 to 0.7, e.g., about 0.4 to 0.6. The value of the pitch A1 of the first stripe pattern 351 divided by the pitch p of the light condensing pattern unit 23 is referred to as a mismatch value.

As the mismatch value approaches about 0.5, the moiré effect can be further reduced or eliminated.

The angle between the light condensing pattern unit 23 and the first stripe pattern 351 may be about 0° since the patterns are parallel to each other. The angle between the light condensing pattern unit 23 and the second stripe pattern 352 may be about 90° since they are perpendicular to each other.

Table 1, below, shows mismatch values as a function of changes in the value p and the value A1 of the light condensing pattern unit 23 and the panel pattern unit 35 respectively, and the corresponding moiré degree.

TABLE 1

| | | A1 | | | |
|---|---|---|---|---|---|
| No. | p value(μm) | value(μm) | A1/p | mismatch value | moiré degree |
| 1 | 21 | 171 | 8.14 | 0.14 | Strong |
| 2 | 20.3 | 171 | 8.42 | 0.42 | None |
| 3 | 22.8 | 189 | 8.29 | 0.29 | Weak |
| 4 | 21 | 198 | 9.43 | 0.43 | None |
| 5 | 20.8 | 198 | 9.52 | 0.52 | None |
| 6 | 21 | 208.5 | 9.93 | 0.93 | Weak |
| 7 | 20.3 | 208.5 | 10.27 | 0.27 | Weak |
| 8 | 22.8 | 213 | 9.34 | 0.34 | None |
| 9 | 20.3 | 213 | 10.49 | 0.49 | None |
| 10 | 21 | 213 | 10.14 | 0.14 | Strong |
| 11 | 21 | 219 | 10.43 | 0.43 | None |
| 12 | 20.8 | 219 | 10.53 | 0.53 | None |
| 13 | 22.8 | 219 | 9.61 | 0.61 | None |
| 14 | 20.3 | 219 | 10.79 | 0.79 | Weak |
| 15 | 21 | 225 | 10.71 | 0.71 | Slight |
| 16 | 21.4 | 225 | 10.51 | 0.51 | None |
| 17 | 21 | 231 | 11.00 | 0 | Weak |
| 18 | 20.3 | 231 | 11.38 | 0.38 | None |

As shown in Table 1, the moiré effect may not be observed when the mismatch value is in the range of approximately 0.3 to 0.7. Furthermore, when the mismatch value approaches 0.5, the moiré effect is still weaker or not observed. The invention is not restricted by the about 0.3 to 0.7 range, and as shown in Table 1, a weak moiré degree is exhibited outside this range.

Also, since the moiré effect is not solely caused by the pattern mismatch, various factors, e.g., the angle of convex parts 232 of the light condensing pattern unit 23, may be considered when manufacturing an LCD device. However, the moiré effect may be further reduced or eliminated be taking the mismatch value into consideration.

Although the panel pattern unit 35 described above may be formed in a mesh form such as a black matrix, the present invention is not limited thereto.

FIG. 4 shows a structure in which both the panel pattern unit 35 and the light condensing pattern unit 23 may be in a stripe pattern, and the panel pattern unit 35 and the light condensing pattern unit 23 may be parallel to each other. That is, the angle between the panel pattern unit 35 and the light condensing panel unit 23 may be about 0°. Additionally, the pixels (L) which display images may be disposed between the panel pattern units 35.

The panel pattern unit 35 may be of various types, e.g., various types of metal wiring of LCD devices, an opaque insulation layer for insulating between wirings or electrodes, etc.

Even in such structures, the pitch A2 of the panel pattern unit 35 in the stripe pattern and the pitch p of the light condensing pattern unit 23 may satisfy the approximate relation of 0.3≦(A2/p−N)≦0.7, where N is an integer part of A2/p. The optimal value of A2/p−N may be approximately equal to 0.5.

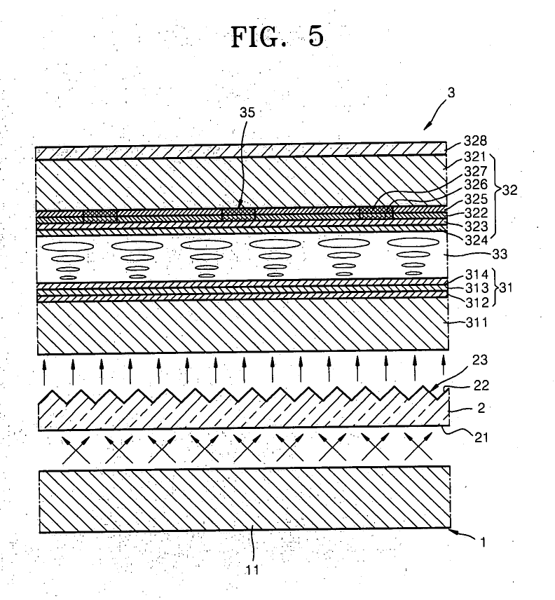

FIG. 5 illustrates an example of an LCD device according to an embodiment of the present invention. In FIG. 5, particulars of the panel pattern unit 35 may be the same as described above.

Referring to FIG. 5, a first substrate 31 of an LCD panel 3 may include a rear substrate element 311 which may be formed of a glass material or a transparent plastic material. A transparent electrode 312 may be a material such as an indium tin oxide (ITO) or indium zinc oxide (IZO) on the rear substrate 311, and an insulation film 313 may be on the transparent electrode 312. An alignment film 314 may also be on the insulation film 313. When the LCD panel 3 is a TFT-LCD panel, the rear substrate 311 may further include multiple thin film transistors (TFTs) and the TFTs may be electrically connected to the transparent electrodes 312 which are patterned for each pixel.

In the display, the second substrate 32 facing the first substrate 31 may include a front substrate 321 of, e.g., a glass material, a transparent plastic material, etc. A color filter 325 may be beneath the front substrate 321, and a transparent electrode 322 may be formed of, e.g., ITO, IZO, etc. beneath the color filter 325. An insulation film 323 may be beneath the transparent electrode 322, and an alignment film 324 may be beneath the insulation film 323.

The color filter 325 may be patterned with red (R), green (G) and blue (B) colors for each pixel, and a light absorbing black matrix 327 may be between each pixel. The transparent electrode 322 may be patterned with a predetermined pattern. An inter-insulation film 326 may be between the transparent electrodes 322.

In addition, a polarized light film 328 may be attached to the front of substrate 321. A liquid crystal 33 may be disposed between the first substrate 31 and second substrate 32. In the LCD panel 3 having such structures, the panel pattern unit 35 may be the black matrix 327. A backlight 1 may be disposed under the LCD panel 3, and more particularly, a light guide plate 11 of the backlight 1 may be disposed under the LCD panel 3. Additionally, a prism sheet 2 may disposed between the backlight 1 and the LCD panel 3.

The moiré effect may be reduced or eliminated by adjusting the relation between the pattern pitch of the panel pattern unit 35 and the pattern pitch of the light condensing pattern unit 23 of the prism sheet 2.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A liquid crystal display, comprising:
a liquid crystal display panel including a panel pattern unit;
a backlight; and
a prism sheet disposed between the liquid crystal display panel and the backlight, the prism sheet including a light condensing pattern unit on a side facing the liquid crystal display panel,
wherein a pattern pitch A of the panel pattern unit and a pattern pitch p of the light condensing pattern unit satisfy formula 1 below:
0.3≦(A/p−N)≦0.7 (formula 1)
where N is an integer part of A/p.

2. The liquid crystal display as claimed in claim 1, wherein A/p−N is approximately 0.5.

3. The liquid crystal display as claimed in claim 1, wherein the panel pattern unit is between pixels of the liquid crystal display panel.

4. The liquid crystal display as claimed in claim 1, wherein the panel pattern unit is a light absorbing pattern between pixels of the liquid crystal display panel.

5. The liquid crystal display as claimed in claim 1, wherein the panel pattern unit is a wiring pattern of the liquid crystal display panel.

6. The liquid crystal display as claimed in claim 1, wherein the panel pattern unit is an insulation film of the liquid crystal display panel.

7. The liquid crystal display as claimed in claim 1, wherein an angle between a pattern of the panel pattern unit and a pattern of the light condensing pattern unit is about 0° or about 90°.

8. The liquid crystal display as claimed in claim 1, wherein the light condensing pattern unit has a stripe form.

9. The liquid crystal display as claimed in claim 1, wherein the panel pattern unit has a mesh form.

10. The liquid crystal display as claimed in claim 1, wherein the panel pattern unit has a stripe form.

11. A liquid crystal display, comprising:
a panel pattern unit;
a light source; and
a prism sheet disposed between the panel pattern unit and the light source, the prism sheet including a light condensing pattern unit on a side facing the panel pattern unit,
wherein a pattern pitch A of the panel pattern unit and a pattern pitch p of the light condensing pattern unit satisfy formula 1 below:
0.3≦(A/p−N)≦0.7 (formula 1)
where N is an integer part of A/p.

12. The liquid crystal display as claimed in claim 11, wherein A/p−N is approximately 0.5.

13. The liquid crystal display as claimed in claim 1, wherein the panel pattern unit is between pixels of a liquid crystal display panel.

14. The liquid crystal display as claimed in claim 13, wherein the panel pattern unit is a light absorbing pattern between pixels of the liquid crystal display panel.

15. The liquid crystal display as claimed in claim 13, wherein the panel pattern unit is a wiring pattern of the liquid crystal display panel.

16. The liquid crystal display as claimed in claim 13, wherein the panel pattern unit is an insulation film of the liquid crystal display panel.

17. The liquid crystal display as claimed in claim 11, wherein an angle between a pattern of the panel pattern unit and a pattern of the light condensing pattern unit is about 0° or about 90°.

18. The liquid crystal display as claimed in claim 11, wherein the light condensing pattern unit has a stripe form.

19. The liquid crystal display as claimed in claim 11, wherein the panel pattern unit has a mesh form.

20. The liquid crystal display as claimed in claim 11, wherein the panel pattern unit has a stripe form.
